(19) United States
(12) Patent Application Publication
(10) Pub. No.: US 2021/0160844 A1
(43) Pub. Date: May 27, 2021

(54) User Equipment and Method of New Radio Vehicle-to-Everything Communication of Same

(71) Applicant: GUANGDONG OPPO MOBILE TELECOMMUNICATIONS CORP., LTD., Dongguan (CN)

(72) Inventors: Huei-Ming Lin, South Yarra (AU); Zhenshan Zhao, Dongguan (CN); Qianxi Lu, Dongguan (CN)

(21) Appl. No.: 17/165,577

(22) Filed: Feb. 2, 2021

Related U.S. Application Data
(63) Continuation of application No. PCT/CN2018/099222, filed on Aug. 7, 2018.

(51) Int. Cl. H04W 72/04; H04L 1/00; H04W 4/40

(52) U.S. Cl. CPC H04W 72/0406; H04W 4/40; H04L 1/0061

(57) ABSTRACT

A user equipment (UE) and a method of new radio vehicle-to-everything (NR-V2X) communication of same are provided. The method includes encoding a sidelink control information (SCI), scrambling at least one cyclic redundancy check (CRC) using at least one radio network temporary identifier (RNTI) value, performing at least one scrambled CRC attachment on the SCI, and transmitting, to another UE, a plurality of V2X messages including the at least one scrambled CRC attachment on the SCI in corresponding new radio (NR) sidelink resources.

### CROSS-REFERENCE TO RELATED APPLICATION(S)

This application is a continuation application of International Application No. PCT/CN2018/099222, filed on Aug. 7, 2018, the entire disclosure of which is hereby incorporated by reference.

### TECHNICAL FIELD

The present disclosure relates to the field of communication systems, and more particularly, to a user equipment (UE) and a method of new radio vehicle-to-everything (NR-V2X) communication of same.

### BACKGROUND

In an evolution and advancement of intelligent transportation system (ITS), so far there have been two main radio access technologies (RATs), namely 802.11p developed by an institute of electrical and electronics engineers (IEEE) and a long term evolution vehicle-to-everything (LTE-V2X) developed by 3rd generation partnership project (3GPP). In an LTE-V2X system, V2X communications are exchanged directly between UE terminals over a sidelink resource pool 100 as exemplary illustrated in FIG. 1. Whenever a V2X message transport block (TB) is transmitted in the sidelink resource pool 100 using one or more of sidelink sub-channels 101, both physical sidelink control channel (PSCCH) 102 and its associated physical sidelink shared channel (PSSCH) 103 are sent from a transmitting UE (Tx-UE) at same time, where the PSCCH 102 carries sidelink control information (SCI) containing all resource scheduling, reservation, priority and transmission format information about the associated PSSCH 103. In addition, the associated PSSCH 103 carries an actual V2X message data payload.

During a channel encoding process of the SCI, an attached cyclic redundancy check (CRC) is not scrambled by any radio network temporary identifier (RNTI) value. RNTI values, in the LTE system, are usually configured by a serving network base station (BS) to every UE or sometimes the RNTI values can be derived by the UE itself for identifying a purpose of a received control signaling. For example, system information RNTI (SI-RNTI) is used for scrambling downlink control information when the BS is delivering system information (SI) to UEs and a cell RNTI (C-RNTI) is used when a physical downlink shared channel (PDSCH) is transmitted to a UE. Since the LTE-V2X system is designed for UE transmitting basic safety messages, which need to be received by all surrounding UEs in proximity, using a broadcast type of transmission, there is no real need for scrambling a SCI CRC attachment by a particular RNTI value. For a future new radio-V2X (NR-V2X) system, however, it needs to support various types of service, use case, and transmission, of which some of them are not necessary or even intended for all UEs in a field to receive. If a receiving UE (Rx-UE) attempt to decode all V2X messages within a resource pool, it may take a while for the UE to complete the decoding as it depends on UE's processing capability, such as a number of processing chains. Subsequently, it may jeopardize urgent messages with very stringent latency requirement that need to be processed and received by UE upper/application layers.

### SUMMARY

An object of the present disclosure is to propose a user equipment (UE) and a method of new radio vehicle-to-everything (NR-V2X) communication of same.

In a first aspect of the present disclosure, a user equipment (UE) in a new radio vehicle-to-everything (NR-V2X) communication system includes a memory, a transceiver, and a processor coupled to the memory and the transceiver. The processor is configured to encode a sidelink control information (SCI), scramble at least one cyclic redundancy check (CRC) using at least one radio network temporary identifier (RNTI) value, perform at least one scrambled CRC attachment on the SCI, and control the transceiver to transmit, to another UE, a plurality of V2X messages including the at least one scrambled CRC attachment on the SCI in corresponding new radio (NR) sidelink resources.

In a second aspect of the present disclosure, a method of new radio vehicle-to-everything (NR-V2X) communication of a user equipment (UE) includes encoding a sidelink control information (SCI), scrambling at least one cyclic redundancy check (CRC) using at least one radio network temporary identifier (RNTI) value, performing at least one scrambled CRC attachment on the SCI, and transmitting, to another UE, a plurality of V2X messages including the at least one scrambled CRC attachment on the SCI in corresponding new radio (NR) sidelink resources.

In a third aspect of the present disclosure, a user equipment (UE) in a new radio vehicle-to-everything (NR-V2X) communication system includes a memory, a transceiver, and a processor coupled to the memory and the transceiver. The processor is configured to control the transceiver to receive a plurality of V2X messages including at least one scrambled CRC attachment on a sidelink control information (SCI) form another UE in corresponding new radio (NR) sidelink resources, decode a sidelink control information (SCI), and descramble the at least one scrambled CRC attachment on the SCI using at least one radio network temporary identifier (RNTI) value.

In a fourth aspect of the present disclosure, new radio vehicle-to-everything (NR-V2X) communication of a user equipment (UE) includes receiving a plurality of V2X messages including at least one scrambled CRC attachment on a sidelink control information (SCI) form another UE in corresponding new radio (NR) sidelink resources, decoding a sidelink control information (SCI), and descrambling the at least one scrambled CRC attachment on the SCI using at least one radio network temporary identifier (RNTI) value.

In the embodiment of the present disclosure, the UE and the method of NR-V2X communication of same include scramble or descramble the CRC using the at least one RNTI value.

### BRIEF DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field can obtain other figures according to these figures without paying the premise.

FIG. 1 is a diagram of a structure of a sidelink resource pool in a long term evolution vehicle-to-everything (LTE-V2X) system according to existing technologies.

FIG. 2 is a block diagram of at least one user equipment in a new radio vehicle-to-everything (NR-V2X) communication system according to an embodiment of the present disclosure.

FIG. 3 is a diagram of a structure of a sidelink resource pool in a NR-V2X communication system according to an embodiment of the present disclosure.

FIG. 4 is a diagram of a structure of a sidelink resource pool in a NR-V2X communication system according to another embodiment of the present disclosure.

FIG. 5 is a flowchart illustrating a method of NR-V2X communication of a user equipment according to an embodiment of the present disclosure.

FIG. 6 is a flowchart illustrating a method of NR-V2X communication of a user equipment according to another embodiment of the present disclosure.

FIG. 7 is a block diagram of a system for wireless communication according to an embodiment of the present disclosure.

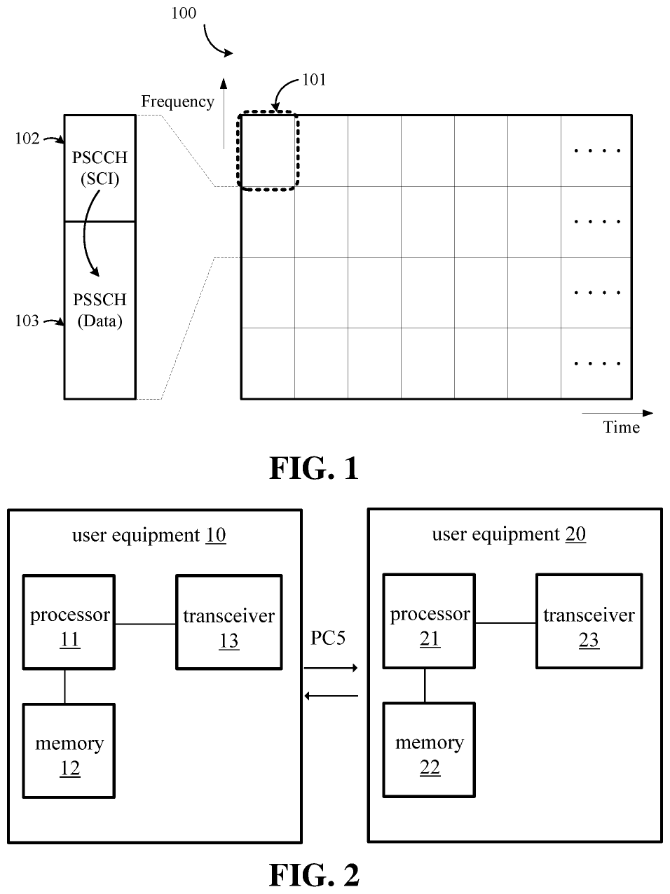

### DETAILED DESCRIPTION

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

FIG. 2 illustrates that, in some embodiments, at least one user equipment (UE) 10 in a new radio vehicle-to-everything (NR-V2X) communication system according to an embodiment of the present disclosure. The UE 10 may include a processor 11, a memory 12 and a transceiver 13. The processor 11 may be configured to implement proposed functions, procedures and/or methods described in this description. Layers of radio interface protocol may be implemented in the processor 11. The memory 12 is operatively coupled with the processor 11 and stores a variety of information to operate the processor 11. The transceiver 13 is operatively coupled with the processor 11, and transmits and/or receives a radio signal.

Another UE 20 may include a processor 21, a memory 22 and a transceiver 23. The processor 21 may be configured to implement proposed functions, procedures and/or methods described in this description. Layers of the radio interface protocol may be implemented in the processor 21. The memory 22 is operatively coupled with the processor 21 and stores a variety of information to operate the processor 21. The transceiver 23 is operatively coupled with the processor 21, and transmits and/or receives a radio signal.

The processors 11 and 21 may include application-specific integrated circuit (ASIC), other chipset, logic circuit and/or data processing device. The memories 12 and 22 may include read-only memory (ROM), random access memory (RAM), flash memory, memory card, storage medium and/or other storage device. The transceivers 13 and 23 may include baseband circuitry to process radio frequency signals. When the embodiments are implemented in software, the techniques described herein can be implemented with modules (e.g., procedures, functions, and so on) that perform the functions described herein. The modules can be stored in the memories 12 and 22 and executed by the processors 11 and 21. The memories 12 and 22 can be implemented within the processors 11 and 21 or external to the processors 11 and 21 in which case those can be communicatively coupled to the processors 11 and 21 via various means as is known in the art.

The communication between the UE 10 and the UE 20 relates to vehicle-to-everything (V2X) communication including vehicle-to-vehicle (V2V), vehicle-to-pedestrian (V2P), and vehicle-to-infrastructure/network (V2I/N) according to a sidelink technology developed under 3rd generation partnership project (3GPP) 5th generation NR (5G-NR) radio access technology. The UE 10 and the UE 20 are communicated with each other directly via a sidelink interface such as a PC5 interface.

In some embodiments, the processor 11 of the UE 10 is configured to encode a sidelink control information (SCI), scramble at least one cyclic redundancy check (CRC) using at least one radio network temporary identifier (RNTI) value, perform at least one scrambled CRC attachment on the SCI, and control the transceiver to transmit, to the UE 20, a plurality of V2X messages including the at least one scrambled CRC attachment on the SCI in corresponding new radio (NR) sidelink resources.

In some embodiments, the processor 21 of the UE 20 is configured to control the transceiver 23 to receive a plurality of V2X messages including at least one scrambled CRC attachment on a sidelink control information (SCI) form the UE 10 in corresponding new radio (NR) sidelink resources, decode a sidelink control information (SCI), and descramble the at least one scrambled CRC attachment on the SCI using at least one radio network temporary identifier (RNTI) value.

In the embodiment of the present disclosure, the UE 10 and 20 and the method of NR-V2X communication of same include scramble or descramble the CRC using the at least one RNTI value, so as to provide at least one of low UE processing complexity and high urgency messages being prioritized.

In some embodiments, the transceiver 13 is configured to transmit the V2X messages including the at least one scrambled CRC attachment on the SCI to the UE 20 over a NR-sidelink resource pool, a NR-sidelink carrier, or a NR-sidelink bandwidth part (BWP) in the corresponding new radio (NR) sidelink resources. The transceiver 23 is configured to receive the V2X messages including the at least one scrambled CRC attachment on the SCI from the UE 10 over a NR-sidelink resource pool, a NR-sidelink carrier, or a NR-sidelink bandwidth part (BWP) in the corresponding new radio (NR) sidelink resources. The UE 10 is a message transmitting UE, and the UE 20 is a message receiving UE.

In some embodiments, the UE 10 transmits a unicast message to the UE 20, the at least one RNTI value is generated according to an ID of the UE 20 for scrambling the at least one scrambled CRC attachment on the SCI of the UE 10. The UE 20 receives a unicast message from the UE 10, the at least one RNTI value is generated according to an ID of the UE 20 for descrambling the at least one scrambled CRC attachment on the SCI of the UE 10.

In some embodiments, the processor 11 or 21 is configured to set a plurality of priority orders among different RNTI values according to the V2X messages. The processor 11 or 21 is configured to determine the road-safety related messages as a first priority, the autonomous driving messages as a second priority, the vehicle platooning messages as a third priority, the remote driving messages as a fourth priority, the extended sensor data sharing messages as a fifth priority, the commercial related messages as a sixth priority, and the non-road-safety messages as a seventh priority. The transceiver 13 is configured to transmit the V2X messages using the at least one RNTI value according to a message transmission type. The transceiver 13 is configured to transmit the V2X messages using the at least one RNTI value according to a message transmission type and a priority order. The transceiver 23 is configured to receive the V2X messages using the at least one RNTI value according to a message transmission type. The transceiver 23 is configured to receive the V2X messages using the at least one RNTI value according to a message transmission type and a priority order.

In some embodiments, the RNTI value is predefined, configured by a network base station (BS), pre-configured to the message transmitting UE 10 and the message receiving UE 20, self-derived by the message transmitting UE, given by a group of UEs, or given by a cluster header UE. The at least one RNTI value is defined for a broadcast transmission, a groupcast transmission, and/or a unicast transmission.

In some embodiments, when the at least one RNTI value is defined for the broadcast transmission, the at least one RNTI value is common and known to all UEs, regardless of the UEs are inside a network overage or out of the network coverage, and regardless of the UEs are operating in a network assisted scheduling mode or an autonomous resource selection mode. When the at least one RNTI value is defined for the broadcast transmission, the at least one RNTI value is predetermined and fixed. When the at least one RNTI value is defined for the broadcast transmission, the at least one RNTI value is network BS configured, pre-configured, or derived per the NR-sidelink resource pool, the NR-sidelink BWP, or the NR-sidelink carrier according to a resource pool identity (ID), a carrier index, a BWP index, a group destination ID, and/or other parameters.

In some embodiments, when the at least one RNTI value is defined for the groupcast transmission, the at least one RNTI value is common and known to all UEs within a same group. When the at least one RNTI value is defined for the groupcast transmission, the at least one RNTI value is generated according to a unique group ID assigned by the network BS or derived base on a group UE ID, a cluster header UE ID, at least one ID of at least one selected UE, IDs of all UEs in the same group, a number of the UEs in the same group, a cell ID, and/or other parameters.

In some embodiments, when the at least one RNTI value is defined for the unicast transmission, the at least one RNTI value is common and known to both communicating UEs. When the at least one RNTI value is defined for the unicast transmission, the at least one RNTI value have two different values.

In some embodiments, the at least one RNTI value is assigned by the network BS or generated according to a combination of IDs of both UEs. The V2X messages include at least one of road-safety related messages, autonomous driving messages, vehicle platooning messages, remote driving messages, extended sensor data sharing messages, commercial related messages, and non-road-safety messages.

In some embodiments, in a step of a CRC attachment during a SCI encoding, a generated CRC may be scrambled by a RNTI for all sidelink message transmissions in a NR-sidelink carrier, NR-sidelink bandwidth part (BWP), or NR-sidelink resource pool. The main purpose and motivation of the CRC scrambling by a RNTI value is to save any receiving UE (Rx-UE) processing time, resource, and power consumption from not attempting to decode V2X data messages that are not intended or relevant for the Rx-UE 20. And thus, to achieve a shortened processing time for decoding relevant sidelink message data and more UE processing resources and capacity can be alternatively used for other purposes, such as decoding of sidelink messages from other NR-sidelink pools/BWPs/carriers and cellular downlink (DL) reception.

In some embodiments, depending on the intended type of message transmission, such as unicast, groupcast, or broadcast transmission, the RNTI value that may be used by the Tx-UE 10 for CRC scrambling and Rx-UE 20 for descrambling may be different.

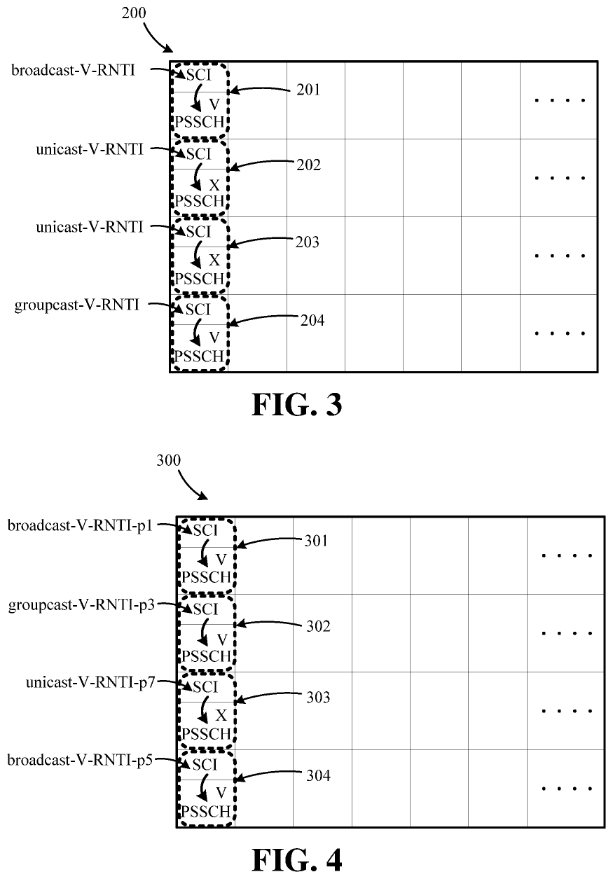

As exemplary illustrated in FIG. 3, four separate V2X messages are transmitted in a same time duration (e.g. one NR slot) over a NR-V2X resource pool 200 in a first NR-resource 201, a second NR-resource 202, a third NR-resource 203, and a fourth NR-resource 204. For the separate V2X messages transmitted in the first NR-resource 201, the second NR-resource 202, the third NR-resource 203, and the fourth NR-resource 204, their SCI CRCs have been scrambled by a broadcast-V-RNTI, a unicast-V-RNTI, a unicast-V-RNTI, and a groupcast-V-RNTI respectively. For a Rx-UE 20 that operates in the same NR-V2X resource pool 200 and has been given the same broadcast-V-RNTI and groupcast-V-RNTI, the Rx-UE 20 can correctly descramble SCI CRCs in the first NR-resource 201 and the fourth NR-resource 204, successfully extract scheduling and transmission information of their associated PSSCHs and subsequently proceed to decode data messages in the first NR-resource 201 and the fourth NR-resource 204. Since the Rx-UE 20 does not have knowledge about the two unicast-V-RNTI's used in the second NR-resource 202 and the third NR-resource 203, the Rx-UE 20 cannot correctly descramble SCI CRCs of the second NR-resource 202 and the third NR-resource 203 and also not able to successfully extract scheduling and transmission information of their associated PSSCH's. Thus, the Rx-UE 20 skips/not attempting to decode data messages in the second NR-resource 202 and the third NR-resource 203.

In some embodiments, depending on the type of sidelink transmission, such as unicast, groupcast, or broadcast transmission and priority of the message to be sent (priority 1, priority 2, priority 3 and so on), a specific RNTI value may be used to scramble and descramble message SCI CRC attachment. The order of message priority could be determined based on the type of service or use case that the message is associated with. By setting priority orders among different RNTI values, it helps the message Rx-UE 20 to determine the order in which the processor 21 may decode PSSCH. From doing so, this may allow early decoding of more urgent and important data messages first and to ensure their latency requirements are met.

In some embodiments, a set of possible types of service could be road-safety, non-road-safety and commercial related. A set of possible V2X use cases could be autonomous driving, extended sensor data sharing, vehicle platooning and remote driving. An example of message priority order among these possible services and use cases could be defined as followed:

Priority 1 (p1): road-safety related messages
Priority 2 (p2): autonomous driving messages
Priority 3 (p3): vehicle platooning messages
Priority 4 (p4): remote driving messages
Priority 5 (p5): extended sensor data sharing messages
Priority 6 (p6): commercial related messages
Priority 7 (p7): non-road-safety messages

In some embodiments, when transmitting a V2X message, the Tx-UE 10 uses a specific RNTI value according the message transmission type and its priority order. For example, Tx-UE 10 uses the value for broadcast-V-RNTI-p1 when broadcasting road-safety related messages and uses the value for groupcast-V-RNTI-p3 when transmitting vehicle platooning related messages within a group of UEs. At the receiver end, a Rx-UE 20 uses these specific RNTI values or a sub-set of these values (as it may not be participating in all V2X use cases or subscribed to all services) to descramble all received SCI CRCs and determine the order in which the processor 21 may decode the associated PSSCHs.

As exemplary illustrated in FIG. 4, four separate V2X messages are transmitted in a same time duration (e.g. one NR slot) over a NR-V2X resource pool 300 in a first NR resource 301, a second NR resource 302, a third NR resource 303, and a fourth NR resource 304. For the four separate V2X messages transmitted in the first NR resource 301, the second NR resource 302, the third NR resource 303, and the fourth NR resource 304, their SCI CRCs have been scrambled by a broadcast-V-RNTI-p1, a groupcast-V-RNTI-p3, a unicast-V-RNTI-p7, and a broadcast-V-RNTI-p5 respectively. For the Rx-UE 20 that operates in the same NR-V2X resource pool 300, the Rx-UE 20 is able to correctly descramble SCI CRCs in the first NR resource 301, the second NR resource 302, and the fourth NR resource 304 from using broadcast-V-RNTI-p1, groupcast-V-RNTI-p3, and broadcast-V-RNTI-p5 respectively. Since the Rx-UE 20 is not participating in any of non-road-safety related services and/or engaging in any unicast communication with another UE, the Rx-UE 20 does not have knowledge about the RNTI value used and needed to descramble SCI CRC in the third NR resource 303. And thus, the Rx-UE 20 does not proceed to attempting to decode the associated PSSCH in the third NR resource 303. Among the successfully descrambled SCI CRC's in the first NR resource 301, the second NR resource 302, and the fourth NR resource 304, the Rx-UE 20 is aware of the priority order of each of the used RNTI values and thus proceed to decode their associated PSSCHs in the first NR resource 301 first, the second NR resource 302 second, and then the fourth NR resource 304 the last.

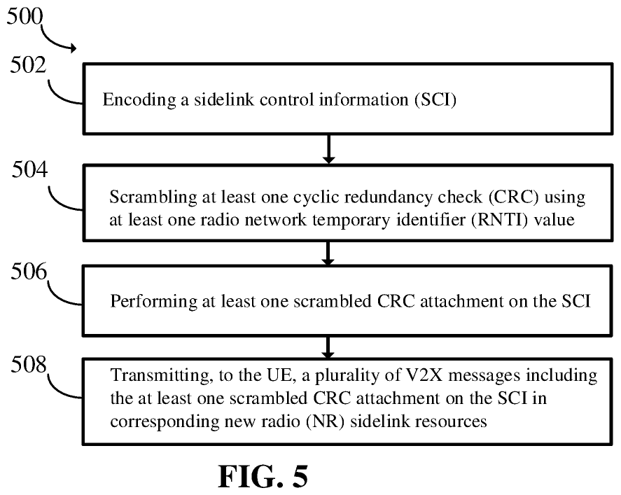

FIG. 5 illustrates a method 500 of NR-V2X communication of the user equipment (UE) 10 according to an embodiment of the present disclosure.

The method 500 includes: at block 502, encoding a sidelink control information (SCI), at block 504, scrambling at least one cyclic redundancy check (CRC) using at least one radio network temporary identifier (RNTI) value, at block 506, performing at least one scrambled CRC attachment on the SCI, and at block 508, transmitting, to the UE 20, a plurality of V2X messages including the at least one scrambled CRC attachment on the SCI in corresponding new radio (NR) sidelink resources.

In some embodiments, the method 500 further includes transmitting the V2X messages including the at least one scrambled CRC attachment on the SCI to the UE 20 over a NR-sidelink resource pool, a NR-sidelink carrier, or a NR-sidelink bandwidth part (BWP) in the corresponding new radio (NR) sidelink resources. The method 500 further includes setting a plurality of priority orders among different RNTI values according to the V2X messages. The method 500 further includes determining the road-safety related messages as a first priority, the autonomous driving messages as a second priority, the vehicle platooning messages as a third priority, the remote driving messages as a fourth priority, the extended sensor data sharing messages as a fifth priority, the commercial related messages as a sixth priority, and the non-road-safety messages as a seventh priority. The method 500 further includes transmitting the V2X messages using the at least one RNTI value according to a message transmission type. The method 500 further includes transmitting the V2X messages using the at least one RNTI value according to a message transmission type and a priority order.

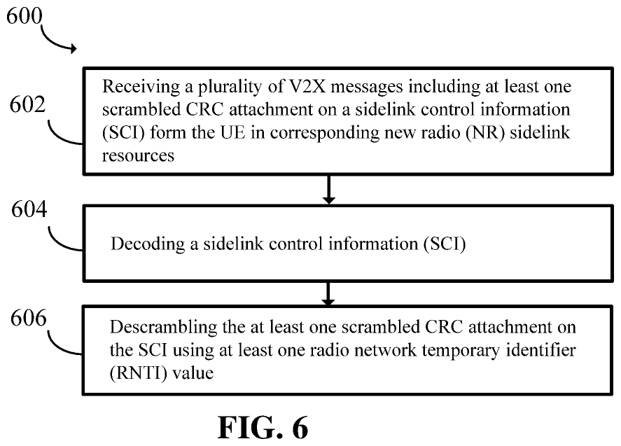

FIG. 6 illustrates a method 600 of NR-V2X communication of the user equipment (UE) 20 according to an embodiment of the present disclosure.

The method 600 includes: at block 602, receiving a plurality of V2X messages including at least one scrambled CRC attachment on a sidelink control information (SCI) form the UE 10 in corresponding new radio (NR) sidelink resources, at block 604, decoding a sidelink control information (SCI), and at block 606, descrambling the at least one scrambled CRC attachment on the SCI using at least one radio network temporary identifier (RNTI) value.

In some embodiments, the method 600 further includes receiving the V2X messages including the at least one scrambled CRC attachment on the SCI from the UE 10 over a NR-sidelink resource pool, a NR-sidelink carrier, or a NR-sidelink bandwidth part (BWP) in the corresponding new radio (NR) sidelink resources. The method 600 further includes setting a plurality of priority orders among different RNTI values according to the V2X messages. The method 600 further includes determining the road-safety related messages as a first priority, the autonomous driving messages as a second priority, the vehicle platooning messages as a third priority, the remote driving messages as a fourth priority, the extended sensor data sharing messages as a fifth priority, the commercial related messages as a sixth priority, and the non-road-safety messages as a seventh priority. The method 600 further includes receiving the V2X messages using the at least one RNTI value according to a message transmission type. The method 600 further includes receiving the V2X messages using the at least one RNTI value according to a message transmission type and a priority order.

In the embodiments, the UE and the method of NR-V2X communication of same include scramble or descramble the CRC using the at least one RNTI value, so as to provide at least one of low UE processing complexity and high urgency messages being prioritized. In details, the embodiments aim to solve unnecessary decoding and processing delay issues for NR-V2X UEs in existing technologies by introducing new RNTI values for scrambling SCI CRC and a simple message urgency identification mechanism that would allow at least one Rx-UE to be able to identify, prioritize and decode only the intended messages. Benefits of adopting the embodiments include lower Rx-UE processing complexity, faster decoding and lower battery consumption, and high urgency messages are prioritized, decoded and passed on to higher layers of the Rx-UE to achieve target latency requirement.

Further, in the embodiments, faster decoding of intended and urgent messages, flexible reuse of processing resources and saving of UE power consumption are all benefits of a new SCI encoding function for NR-V2X communications through scrambling and/or descrambling of message SCI CRC by a RNTI value that is known to both Tx-UE and intended Rx-UE and defining priority order to different RNTI values based on types of service or type of V2X use case. The embodiments are also a combination of techniques/processes that can be adopted in 3GPP specification to create an end product.

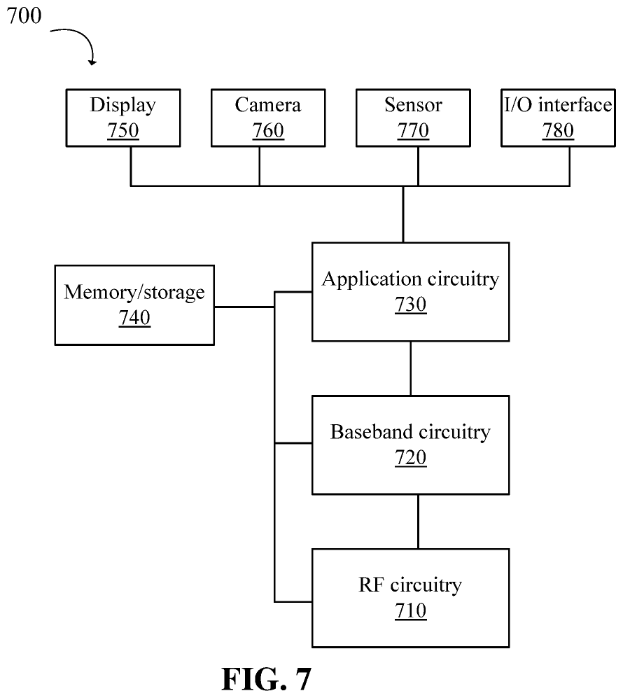

FIG. 7 is a block diagram of a system 700 for wireless communication according to an embodiment of the present disclosure. Embodiments described herein may be implemented into the system using any suitably configured hardware and/or software. FIG. 7 illustrates, for one embodiment, an example system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated.

The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network.

In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules.

In some embodiments, some or all of the constituent components of the baseband circuitry, the application circuitry, and/or the memory/storage may be implemented together on a system on a chip (SOC).

The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display.

In various embodiments, the system 700 may be a mobile computing device such as, but not limited to, a laptop computing device, a tablet computing device, a netbook, an ultrabook, a smartphone, etc. In various embodiments, system may have more or less components, and/or different architectures.

Where appropriate, methods described herein may be implemented as a computer program. The computer program may be stored on a storage medium, such as a non-transitory storage medium.

In the embodiment of the present disclosure, the method and the UE for performing the radio resource selection and contention indication in the wireless communication system includes selecting the sidelink resources from the sidelink resource pool and contending the at least one sidelink resource reserved in advance from the another UE, so as to provide at least one of a better protection to high priority messages in NR-V2X communication and a simple and effective method of sidelink resource selection and contention for NR-V2X communication through selecting and comparing message PPPP level, selecting and comparing message transmission periodicity, and/or selecting and comparing measured RSRP or RSSI level. The embodiment of the present disclosure is a combination of techniques/processes that can be adopted in 3GPP specification to create an end product.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure.

It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments.

Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A user equipment (UE) in a new radio vehicle-to-everything (NR-V2X) communication system, the UE comprising:
a memory;
a transceiver; and
a processor coupled to the memory and the transceiver,
wherein the processor is configured to:
encode a sidelink control information (SCI);
scramble at least one cyclic redundancy check (CRC) using at least one radio network temporary identifier (RNTI) value;
perform at least one scrambled CRC attachment on the SCI; and
control the transceiver to transmit, to another UE, a plurality of V2X messages comprising the at least one scrambled CRC attachment on the SCI in corresponding new radio (NR) sidelink resources.

2. The UE of claim 1, wherein the transceiver is configured to transmit the V2X messages comprising the at least one scrambled CRC attachment on the SCI to the another UE over a NR-sidelink resource pool, a NR-sidelink carrier, or a NR-sidelink bandwidth part (BWP) in the corresponding new radio (NR) sidelink resources.

3. The UE of claim 2, wherein the RNTI value is predefined, configured by a network base station (BS), pre-configured to the message transmitting UE and the message receiving UE, self-derived by the message transmitting UE, given by a group of UEs, or given by a cluster header UE.

4. The UE of claim 3, wherein the at least one RNTI value is defined for at least one of a broadcast transmission, a groupcast transmission, or a unicast transmission.

5. The UE of claim 4, wherein when the at least one RNTI value is defined for the broadcast transmission, the at least one RNTI value is common and known to all UEs, regardless of the UEs are inside a network coverage or out of the network coverage, and regardless of the UEs are operating in a network assisted scheduling mode or an autonomous resource selection mode.

6. The UE of claim 4, wherein when the at least one RNTI value is defined for the broadcast transmission, the at least one RNTI value is predetermined and fixed.

7. The UE of claim 4, wherein when the at least one RNTI value is defined for the broadcast transmission, the at least one RNTI value is network BS configured, pre-configured, or derived per the NR-sidelink resource pool, the NR-sidelink BWP, or the NR-sidelink carrier according to at least one of a resource pool identity (ID), a carrier index, a BWP index, a group destination ID, or other parameters.

8. The UE of claim 4, wherein when the at least one RNTI value is defined for the groupcast transmission, the at least one RNTI value is common and known to all UEs within a same group.

9. The UE of claim 4, wherein when the at least one RNTI value is defined for the groupcast transmission, the at least one RNTI value is generated according to a unique group ID assigned by the network BS or derived base on a group UE ID, a cluster header UE ID, at least one ID of at least one selected UE, IDs of all UEs in the same group, a number of the UEs in the same group, a cell ID, and/or other parameters.

10. The UE of claim 4, wherein when the at least one RNTI value is defined for the unicast transmission, the at least one RNTI value is common and known to both communicating UEs.

11. A method of new radio vehicle-to-everything (NR-V2X) communication of a user equipment (UE), the method comprising:
encoding a sidelink control information (SCI);
scrambling at least one cyclic redundancy check (CRC) using at least one radio network temporary identifier (RNTI) value;
performing at least one scrambled CRC attachment on the SCI; and
transmitting, to another UE, a plurality of V2X messages comprising the at least one scrambled CRC attachment on the SCI in corresponding new radio (NR) sidelink resources.

12. The method of claim 11, further comprising transmitting the V2X messages comprising the at least one scrambled CRC attachment on the SCI to the another UE over a NR-sidelink resource pool, a NR-sidelink carrier, or a NR-sidelink bandwidth part (BWP) in the corresponding new radio (NR) sidelink resources.

13. The method of claim 11, wherein the RNTI value is predefined, configured by a network base station (BS), pre-configured to the message transmitting UE and the message receiving UE, self-derived by the message transmitting UE, given by a group of UEs, or given by a cluster header UE.

14. The method of claim 11, wherein when the at least one RNTI value is defined for a unicast transmission, the at least one RNTI value have two different values.

15. The method of claim 14, wherein the UE transmits a unicast message to the another UE, the at least one RNTI value is generated according to an ID of the another UE for scrambling the at least one scrambled CRC attachment on the SCI of the UE.

16. The method of claim 15, wherein the another UE transmits a unicast message to the UE, the at least one RNTI value is generated according to an ID of the UE for scrambling the at least one scrambled CRC attachment on the SCI of the another UE.

17. The method of claim 11, wherein the at least one RNTI value is assigned by the network BS or generated according to a combination of IDs of both UEs.

18. A user equipment (UE) in a new radio vehicle-to-everything (NR-V2X) communication system, the UE comprising:
a memory;
a transceiver; and
a processor coupled to the memory and the transceiver,
wherein the processor is configured to:
control the transceiver to receive a plurality of V2X messages comprising at least one scrambled CRC attachment on a sidelink control information (SCI) form another UE in corresponding new radio (NR) sidelink resources;
decode a sidelink control information (SCI); and
descramble the at least one scrambled CRC attachment on the SCI using at least one radio network temporary identifier (RNTI) value.

19. The UE of claim 18, wherein the transceiver is configured to receive the V2X messages comprising the at least one scrambled CRC attachment on the SCI from the another UE over a NR-sidelink resource pool, a NR-sidelink carrier, or a NR-sidelink bandwidth part (BWP) in the corresponding new radio (NR) sidelink resources.

20. The UE of claim 18, wherein the at least one RNTI value is defined for a broadcast transmission, a groupcast transmission, and/or a unicast transmission.
